(19) United States
(12) Patent Application Publication
(10) Pub. No.: US 2010/0212351 A1
(43) Pub. Date: Aug. 26, 2010

(54) COOLER CHEST FOR DISPENSING BEVERAGES

(76) Inventors: Michael L. Chapin, New York, NY (US); William Henderson, Maplewood, NJ (US); James Chu, Park Ridge, NJ (US)

Correspondence Address: LADAS & PARRY LLP, 26 WEST 61ST STREET, NEW YORK, NY, 10023, US

(21) Appl. No.: 12/392,144

(22) Filed: Feb. 25, 2009

(51) Int. Cl. F25D 3/08; B67D 5/62; B67D 5/60; B67D 5/06; B65D 25/40

(52) U.S. Cl. 62/457.5; 222/146.6; 222/131; 222/185.1; 222/566

(57) ABSTRACT

A liquid dispensing cooler for beverages in the form of an insulated ice chest having an insulated base, insulated side walls, insulated end walls and an insulated cover; a spigot mounted in one of the chest walls above the base and having a controllable dispensing valve adjacent an exterior surface of the chest wall; at least one inverted bottle having a valve body mounted thereon, said valve body having locking grooves and splines formed thereon on upper portions and having an air venting means integrally formed by crenellations on lowermost portions thereon; a reservoir with a reservoir top wall having a circular opening with locking grooves and splines formed thereon adapted to engage and to support an inverted bottle through said grooves and splines on the valve body; and a delivery tube communicating between the reservoir and the spigot to permit gravity flow of liquid from the reservoir to the spigot.

### BACKGROUND OF THE INVENTION

Portable insulated cooler chests for storing and transporting small quantities of food and beverages are well-known to the art as are cooler chests having a liquid dispensing apparatus integrated therewith. Representative of the current state of the portable cooler prior art are U.S. Pat. No. 5,222,631 (Hood) and U.S. Pat. No. 4,162,029 (Gottsegen et al.).

The present invention relates to improvements in the dispensing apparatus of portable coolers to permit the inexpensive and efficient dispensing of ice-cooled liqueurs in the manner of comparatively expensive bar-top, electric powered, refrigerated dispensers sold under the TAP MACHINE® trademark and well-described, for example, in issued U.S. Pat. Nos. 5,427,276, 5,456,387 and 5,494,195.

### SUMMARY OF THE INVENTION

The apparatus of the new invention provides a lightweight, portable cooler chest having a storage arrangement for securely stowing and cooling, with ice rather than electric refrigeration, a plurality of bottles of beverages, typically alcoholic liqueurs whose taste is enhanced when served at very low temperatures. Importantly, a closed fluid reservoir or well having a pair of integral bottle mounting sockets formed in its top wall plate is supported in the chest adjacent to and above an external spigot mounted at the lower portion of the cooler chest. A delivery tube connects the reservoir or well to the spigot to permit gravity flow of the chilled fluid to the spigot.

Special new mounting valves are provided for attachment to liqueur bottles whose refrigerated fluid contents are to be dispensed. Importantly, the valves are adapted to be locked into the well sockets to hold integrally inverted bottles securely in place in the well wall, and, when inverted and engaged with activation pins formed on the bottom of the well, to permit fluid to escape from the inverted bottles to the well for subsequent selective dispensing through the spigot.

For a more complete understanding of the present invention, reference should be made to the following detailed description of the new cooler chest taken in conjunction with the accompanying drawings.

### DESCRIPTION OF THE DRAWINGS

FIG. 1 is an exploded perspective view of the fundamental cooler chest of the present invention;

FIG. 2 is an exploded perspective view of the inverted bottles, new mounting valves, and fluid well of the present invention;

FIG. 3 is a perspective view of the closed cooler chest with external spigot;

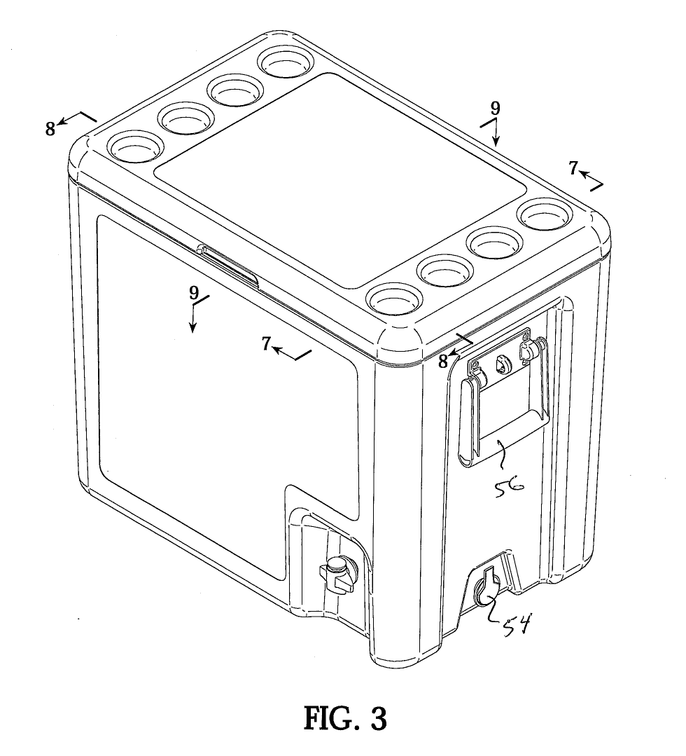

FIG. 4 is a bottom plan view of the well;

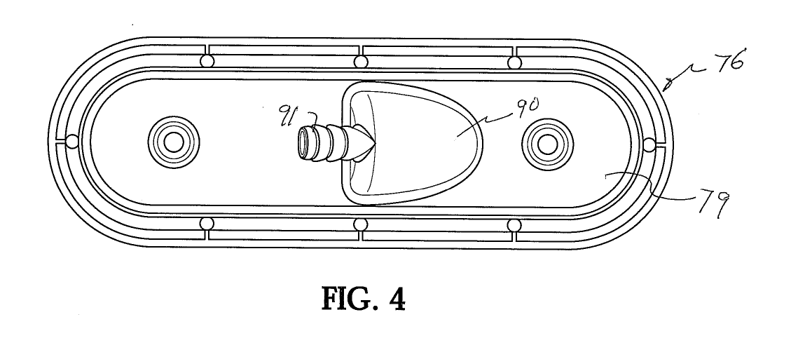

FIG. 5 is a top plan view of the well;

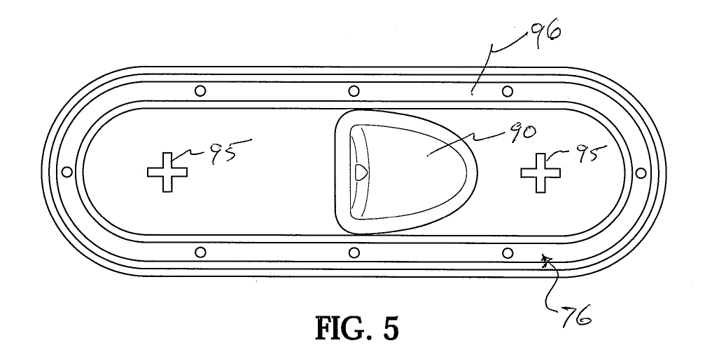

FIG. 6 is a cross-sectional end view of the well taken along line 6-6 of FIG. 3;

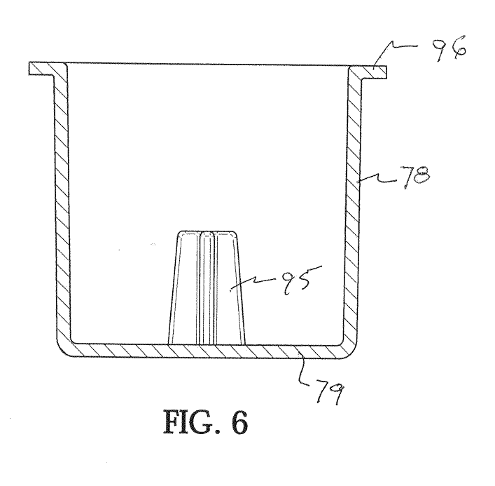

FIG. 7 is a cross-sectional view of the cooler taken along line 7-7 of FIG. 3;

FIG. 8 is a cross-sectional view of the cooler taken along line 8-8 of FIG. 3;

FIG. 9 is a cross-sectional view of the cooler taken along line 9-9 of FIG. 3;

FIG. 10 is a bottom perspective view of the well;

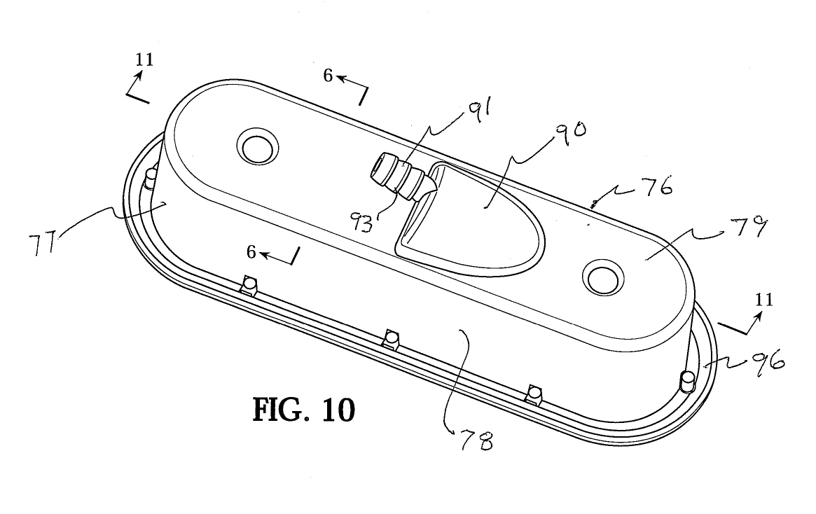

FIG. 11 is a longitudinal cross-section of the well taken along line 11-11 of FIG. 10;

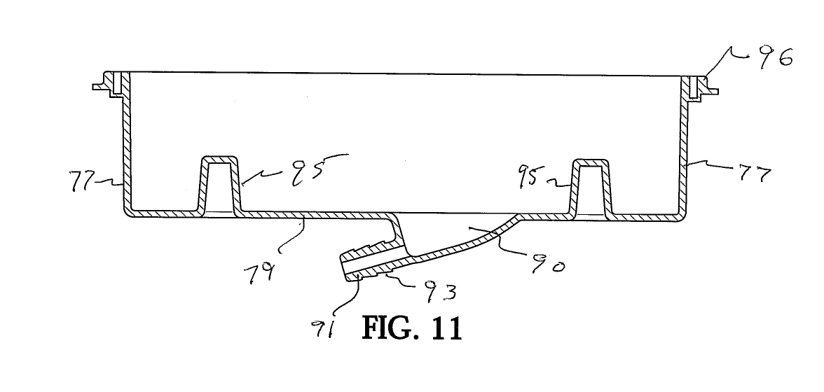

FIG. 12 is a perspective view of the well cover with integral twin bottle support sockets;

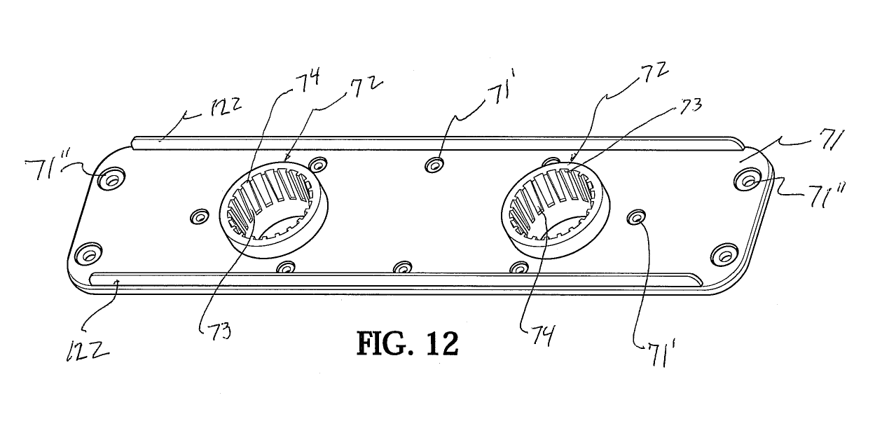

FIG. 13 is a perspective view of the well cover with twin bottle support sockets and hinged twin integral caps for the sockets, and;

FIG. 14 is an exploded perspective view of the new bottle mounting valve.

### DETAILED DESCRIPTION OF THE INVENTION

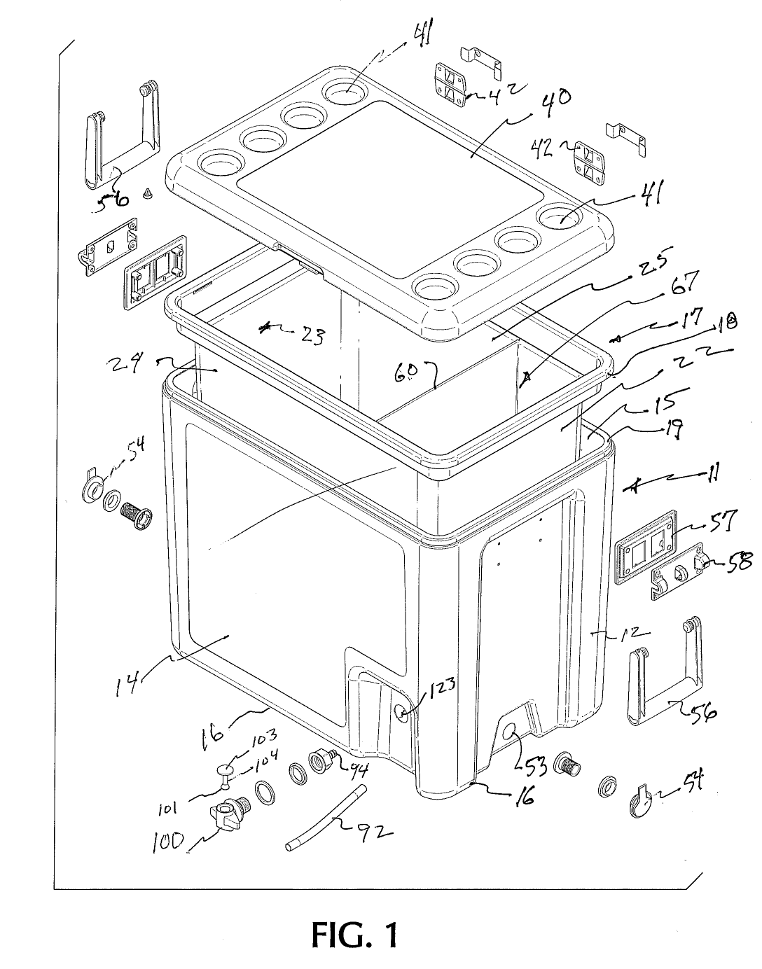

Referring to FIG. 1, the cooler chest 10 of the invention comprises a molded outer polycarbonate shell 11 having vertical end walls 12, 13; vertical front and rear walls 14, 15, and a bottom wall 16. An inner shell 17 having vertical end walls 22, 23; side walls 24, 25; and a bottom wall 26 is nested in the outer shell to define an insulating dead air space between the shells 11, 17. Advantageously, the inner shell has a circumscribing groove 18 formed at its upper edges which groove tightly engages a corresponding rim 19 in an air-tight fit.

A molded cover 40 formed of polycarbonate and having integral cylindrical holders 41 for supporting beverage cups or the like is hingedly connected to the outer shell 11 by hinges 42 fastened to the edge of the cover and the upper edges of the rear wall 15.

Conventional liquid drains 53, having selectively openable stoppers 54, are mounted in drain holes 25 formed at the bottom portions of the end walls 12, 13, 22, 23 adjacent the bottom of the cooler chest to permit drainage of water from melted ice. Conventional, pivoting carrying handles 56 are secured to end walls 12, 13 by mounting hardware 57, 58 attached to the end walls by appropriate fasteners (not shown).

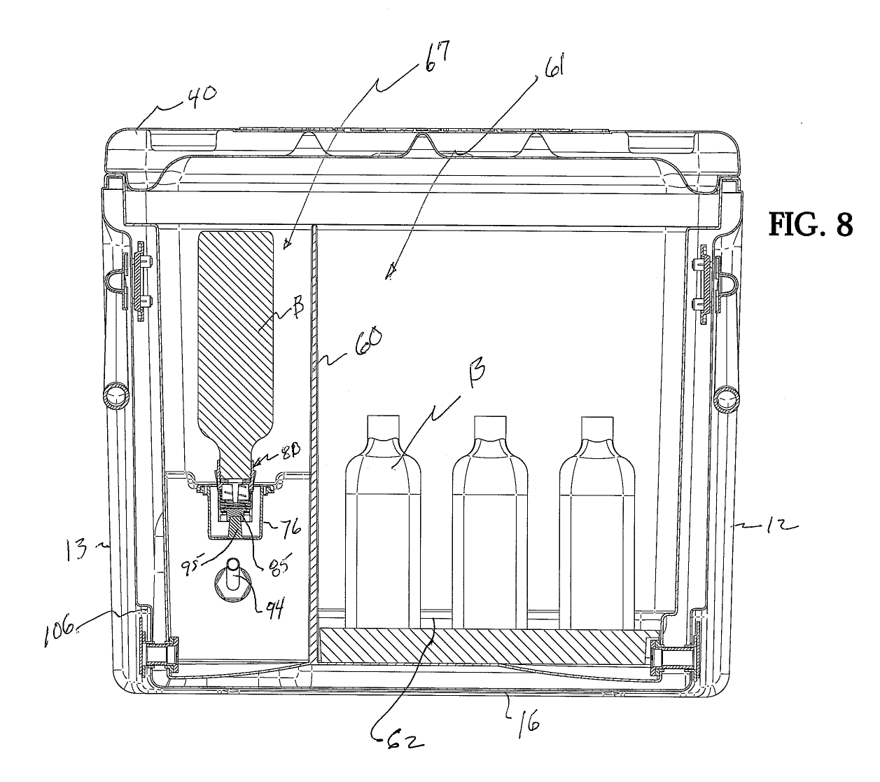

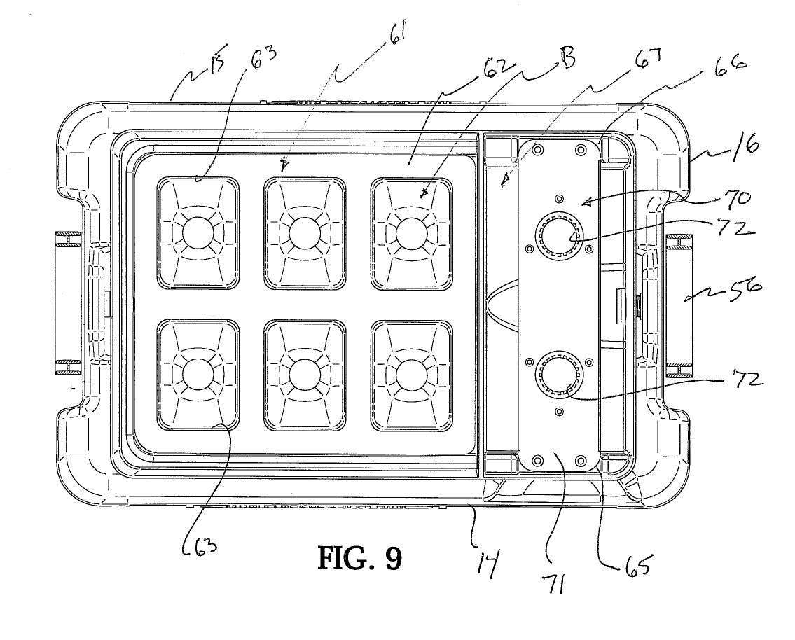

In accordance with the invention, the inner shell 17 is divided by a vertical wall partition 60 into a dispensing portion 67 and a bottle storage portion 61 which includes a molded bottle spacer 62 which rests on the bottom wall 26 of the inner shell. As shown in FIGS. 8 and 9, multiple bottles are adapted to be stored in the storage portion 61 in openings 63 in spacer 62 which openings are generally congruent with the bases of the bottles to be stored. The spacing of the bottles B permits the loading of ice cubes or ice chips around and between the stored bottles.

In accordance with the invention, shelf ledges 65, 66 are formed on inner shell side walls 24, 25 in the dispensing portion 67 to engage and to support a unique fluid reservoir 70 assembly which comprises a full cooler width, top cover plate 71 having a pair of special bottle receiving sockets 72 with grooves 73 and splines 74; a sealing gasket 75; and a fluid well 76. The reservoir 70 is assembled by fastening the cover plate 71 to the well 76 with the gasket 75 therebetween by screws (not shown) passing through plate holes 71′, gasket holes 75′, and well holes 76′ formed in circumscribing lip 96.

A pair of special unitary locking-mounting valves 80 are provided, each having an upper portion in the form of a locking collar 81 with grooves 83 and splines 84 adapted to mate with grooves 73 and splines 74; and a lower valve body portion supporting a spring-biased stopper 85 normally seated in an orifice 86 in a horizontal internal wall of the valve body. The locking-mounting valves 80 are secured to the tops of chilled bottles B by threads 80(a). The bottles are then inverted for support in sockets 72. The lowermost edges of the valve 80 form crenellations 88 to permit air flow into the bottle.

As will be understood and in accordance with the invention, the beverage bottles B are fitted with the mounting-locking valves 80 which are threaded onto the threaded bottle tops after the regular threaded bottle cap closures are removed. The valves 80 are spring-loaded into a normally closed position and have a splined, grooved exterior surface to be described in greater detail hereafter.

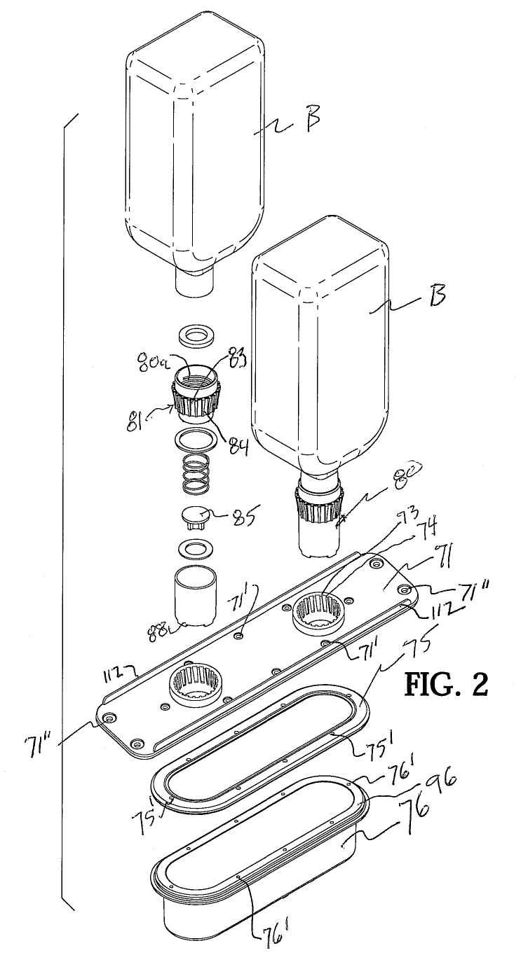

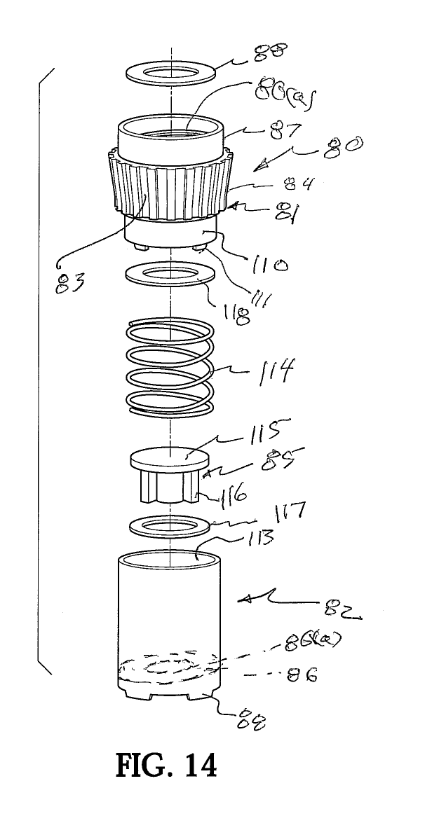

Specifically, and as shown in FIG. 2 and FIG. 14, the locking-mounting valve 80 has an upper valve body portion 81 and a lower valve body 82. The upper valve body portion has a cylindrical collar 87 with internal threads 80(a) which, as explained, are adapted to threadingly engage the bottle top threads T (not shown) which are exposed upon the opening of the bottles B by removing the caps C. Washer 88 seals the collection of bottles B to the threads 80(a).

In accordance with the invention, a frusto-conical array of upper locking splines 84 separated by upper locking grooves 83 are formed integrally with the outer surfaces of the upper valve body 82. The upper splines 84 taper in width from top-to-bottom while the upper grooves 83 therebetween correspondingly taper from bottom-to-top.

The upper valve body portion 81 has an exterior cylindrical surface 110 below the locking splines 84 and grooves 83. Disposed within the upper valve body portion is a spring retainer having depending legs 111.

The lower valve body portion 82 includes an inner surface portion 113 adapted to engage the upper valve body portion 110 in a tight fit in which the fitted portions are permanently bonded by heat welding to complete the assembly of the entire unitary locking-mounting valve. A valve orifice 86(a) is formed in annular orifice plate 86 formed integrally with the lower valve body 82.

Before heat fusing the upper and lower valve body portions 110, 113, the locking-mounting valve assembly 80 is completed by inserting a coil biasing spring 114 in the annular space between the legs 111 and the lower extremity of the upper valve body so that it will engage the valve stopper 85, which has an annular stopper disc 115 of greater diameter than that of orifice 86(a) and a downwardly projecting actuator tab 116.

Sealing elastomeric washer 117 rests on the orifice 86(a) and seats the stopper disc 115. Sealing elastomeric washer 118 is included in the assembly.

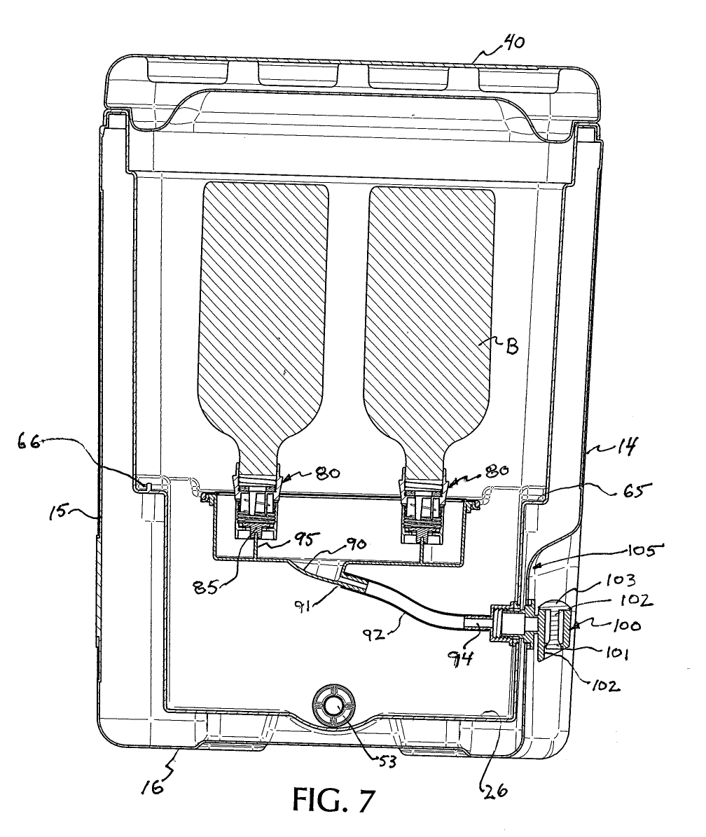

In accordance with the invention, the well 76 is generally oval having arcuate end walls 77 and straight side walls 78. The bottom wall 79 of the well 76 has a sloped outlet trough portion 90 leading to an exit nozzle 91 disposed on the underside of the well. The nozzle 91 receives a flexible delivery tube 92 over its ridged outer surface 93. The tube 92 is connected at its other end to a spigot inlet 94 as shown in FIG. 7. As will be understood, the well is adapted to be charged with fluid from the inverted securely mounted bottles. The fluid will be dispensed through the tube to the spigot 100.

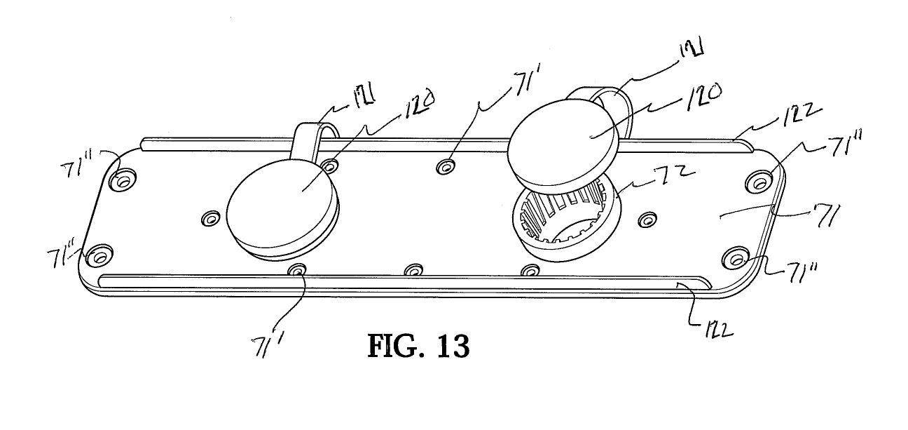

The reservoir 70 is affixed to the cooler chest by fastening the plate 71 by screws (not shown) through holes 71″ to ledges 65, 66. Integral caps 120 (FIG. 13) may be attached by living hinges 121 to plate 71 to cover and close sockets 72 when not receiving bottles B. The plate 71 is stiffened by integral edge ribs 122.

Projecting upwardly from the well of the bottom wall 79 are spaced integral cruciform actuating posts 95 which are each coaxial with the twin mounting sockets 72 in the top cover plate 71. In accordance with the invention, when inverted bottles B are placed in the sockets 72, the splines 83 and grooves 84 will lockingly engage the splines 73 and grooves 74 to hold the inverted bottles securely in place and in communication with the posts 95 in the well 76. The height of the posts 95 is sufficient to engage and to displace the spring-biased stoppers 85 out of their normally orifice closing position in the valve body 80. This movement will permit the flow of liquid from the bottles B into the well 76. With the valve open, air will flow from the well through the orifice and up into the bottles B to fill the void left by the exiting of fluid from the bottle through the valve body and to permit controlled fluid flow. Importantly, the crenellations 88 on the valve body 80 permit air to flow back into the valve 80 until the fluid level in the well reaches the equilibrium level of the orifice 86 and fluid flow stops.

To fill the well 76 to an operative level of fluid, the bottles B with the valves 80 attached are inverted and inserted into the sockets 72 having mating splined/grooved surface. As has been explained, the bottles B will be firmly secured to the housing by virtue of the engagement of the valve body splines/grooves with the associated splines/grooves of the sockets 72 at the top plate 71.

The fluid in the well may be selectively dispensed externally through the spigot 100 disposed in orifice 123 in front wall 14 and operable by selective depression of a resilient elastomeric actuator 101, to permit liquid to pass downwardly by gravity flow out of the spigot opening 102. Specifically, the spigot is a simple, normally closed valve, the stopper 101 having a convex head 103 and shaft 104 which normally bias the bulbous stopper 105 into sealing relation with the discharge orifice 102. Depression of the head 103 displaces the stopper out of sealing relation to permit discharge of fluid. When the fluid level in the well recedes, additional flow from the bottles will restore it to its equilibrium level. Any simple normally closed spigot, faucet, or tap hardware may be employed in the practice of the invention, as should be understood.

Advantageously, the spigot 100 is disposed in recessed portion 105 formed in the outer shell wall 14 so that the spigot 100 does not project beyond the major dimensions of the cooler chest body. Similarly, the drainage holes 25 are disposed in recessed portions 106 formed in the end walls 12, 13 of the outer shell.

It will be appreciated that the new and improved cooler chest provides an economical apparatus for transporting and dispensing popular alcoholic beverages of the type best served when well chilled. The new reservoir and mounting-locking valve mechanisms allow ordinary liqueur bottles to be securely mounted in an inverted position for selective dispensing of chilled beverages from a cooler chest without removing the bottles.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

We claim:

1. A liquid dispensing cooler comprising:
(a) an insulated ice chest having an insulated base, insulated side walls, insulated end walls and an insulated cover;
(b) a spigot mounted in one of said walls above the base having a controllable dispensing valve adjacent an exterior surface of said wall;
(c) said dispensing valve selectively actuatable between open and closed positions mounted in said outlet;
(d) a liquid reservoir supported in said chest higher than said spigot;
(e) at least one inverted bottle having a valve body mounted thereon, said valve body having locking grooves and splines formed thereon on upper portions and having an air venting means integrally formed by crenellations on lowermost portions thereon, said valve body having an exit orifice selectively openable and closeable by a spring-biased, displaceable stopper;
(f) a reservoir with a reservoir top wall having at least one circular opening with locking grooves and splines formed thereon adapted to engage and to support said at least one inverted bottle through said grooves and splines on said valve body;
(g) a delivery tube communicating between the reservoir and the spigot to permit gravity flow of liquid from said reservoir to said delivery tube;
(h) whereby liquid from said at least one inverted bottle may flow controllably into the reservoir through the valve body and into the delivery tube for dispensing liquid externally through the spigot.

2. The cooler chest of claim 1, in which
(a) said reservoir includes an elongated well;
(b) said well has circumscribing side walls and a bottom wall;
(c) the bottom wall has at least one integral vertical actuating pin aligned with each said circular opening and adapted to engage the displaceable stopper in said valve body;
(d) an exit nozzle is integrally formed on the exterior surface of said well;
(e) said delivery tube is attached to said nozzle.

3. The cooler chest of claim 2, in which
(a) said reservoir top plate includes two circular openings;
(b) said exit nozzle is formed in said lower well wall between said two openings.

4. The cooler chest of claim 1, in which
(a) a vertical partition extends between the insulated side walls dividing the chest into a bottle storage portion adapted to store a plurality of bottles and a dispensing portion for supporting the reservoir;
(b) the reservoir top plate is connected to said side walls.

5. The cooler chest of claim 4, in which
(a) shelf ledges are formed in said insulated side walls in the dispensing portion;
(b) said top plate is supported on said ledges.

6. A cooler chest for dispensing liquid comprising:
(a) a closed cooler chest of predetermined geometric configuration;
(b) said chest having a circumscribing side wall, a base wall, and a cover;
(c) said chest having a volume sufficient to accommodate a plurality of bottles, a supply of ice, and a fluid reservoir;
(d) a selectively actuatable dispensing spigot formed in said side wall at a lower region thereof and communicating with said reservoir;
(e) said reservoir having an opening to hold at least one inverted bottle therein for supplying the reservoir with fluid to be dispensed.

7. The cooler chest of claim 6, in which
(a) said reservoir is mounted above the base;
(b) said reservoir includes an exit nozzle;
(c) a delivery tube connects said nozzle to said spigot.
